(19) United States
(12) Patent Application Publication
(10) Pub. No.: US 2002/0116517 A1
(43) Pub. Date: Aug. 22, 2002

(54) Virtual program streaming multi-media system

(76) Inventors: Michael D. Hudson, Portland, OR (US); David A. Nelsen, Portland, OR (US); Chris E. Jenkin, Tigard, OR (US)

Correspondence Address: GERALD B ROSENBERG, NEW TECH LAW, 285 HAMILTON AVE, SUITE 520, PALO ALTO, CA, 94301, US

(21) Appl. No.: 10/052,041

(22) Filed: Jan. 16, 2002

Related U.S. Application Data
(63) Continuation-in-part of application No. 09/946,649, filed on Sep. 5, 2001.
(63) Continuation-in-part of application No. 09/947,048, filed on Sep. 5, 2001.
(60) Provisional application No. 60/262,618, filed on Jan. 17, 2001.
(60) Provisional application No. 60/262,354, filed on Jan. 17, 2001.
(60) Provisional application No. 60/262,539, filed on Jan. 17, 2001.
(60) Provisional application No. 60/262,598, filed on Jan. 17, 2001.

(51) Int. Cl. G06F 15/16

(52) U.S. Cl. 709/231

(57) ABSTRACT

A multi-media content playback system capable of autonomous operation in a virtual program format includes a memory store providing for the storage of a plurality of digital content, a player interface supporting the transfer of a digital content stream to a content player and for receiving user input, and a content control system coupled between the memory store and the player interface. The content control system includes a network proxy that is coupleable through a network to a content server and a control file server and a program control system that is responsive to the programmatic evaluation of a control file. Based on the autonomous evaluation of a control file, digital content is selectively transferred from the content server to the memory store. The control file further defines a dynamic program order for selectively streaming the plurality of digital content from the last-element cache through the player interface as the digital content stream. The dynamic program order is determined based on the control file subject to predetermined selective variation based on the user input.

This application claims the benefit of U.S. Provisional Application Nos. 60/262,618, 60/262,354, 60/262,539, 60/262,598, all filed Jan. 17, 2001.

### BACKGROUND of the INVENTION

1. Field of the Invention

The present invention is generally related to network-based, streaming content delivery systems and, in particular, to a system architecture and methods providing for a virtual network streaming of multi-media content programs.

2. Description of the Related Art

The broad availability of the Internet has fostered a fundamental shift in the way consumers obtain and experience a wide variety of multimedia content. Network connected computers permit consumers to access content either as discrete files, which are downloaded, stored, and subsequently played, or as streamed programs that effectively play as the content is received. Depending on the nature and value of the content, particularly in the case of proprietary content, content providers have adopted different licensing and distribution models to ensure at least some minimum level of control over the content distributed.

Conventionally, direct licensing of downloadable discrete content files provides end-users with the greatest flexibility in freely accessing the digital content. Collections of content files can be accumulated and played at any time and in any order chosen by the user. Due to the file size of such collections, the files are typically stored on multi-media desktop computers with rather substantial disk drive storage capacity. These multi-media computers generally have a permanent, if not persistently active, Internet connection capable of supporting the often lengthy transfer times necessary to download various content files. Such systems are conventionally referred to as tethered computer systems.

Content files can be copied to various mobile computer systems and various conventional personal digital players for subsequent play. Multi-media capable notebook computers and personal digital assistant (PDA) devices can store and support the playback of audio and video content files while untethered. Dedicated personal digital audio players, such as the IPod from Apple Computer, Inc., are principally designed to operate untethered to playback MPEG-3 and other compression format audio content files.

Mobile and portable playback devices conventionally need to be at least temporarily tethered to transfer content to the devices. The discrete licensing model for digital content, at least to the extent that conventional digital rights management (DRM) licensing controls are applied, complicates the content transfer by requiring, directly or indirectly, the content license to be transferred to the playback device. In general, this requires the playback device to be capable of executing a DRM client to implement license control over the transferred content. While the ability to access digital content in an untethered mode is greatly valued by consumers, unfortunately, DRM support has not been widely implemented in appliance type playback devices to date. As a result, the availability of portable digital content under the discrete licensing model is highly constrained and currently undergoing limited growth.

The presentation of digital multi-media content using a streaming data channel model provides a different set of capabilities to the content licensor and a number of significant benefits to content users. Streaming content systems permit so-called net-casting of multi-media programs conventionally through high-bandwidth tethered connections. Any number of different content channels can be defined for any chosen demographic and attractively present new and constantly changing content in program formats. A further benefit of the streaming program format, at least to content licensors, is the support for advertising insertions as a basis for commercially supporting the new content delivery. The streaming data channel model is thus comparable to conventional radio and television networks, which is well recognized as providing for the timely delivery of new content to users at little or no cost.

The streaming data channel model also has the benefit to users of requiring any playback device to have little content storage space and relatively modest data processing capabilities. Further, many different channels of content are freely available for selection immediately on any playback device capable of establishing a streaming data connection.

The playback devices, however, conventionally need to be tethered and are subject to the connection quality of the channel data stream. Audio content programs conventionally require a minimum 32 kbs connection to deliver a readily acceptable performance of the content. Video content programs conventionally require a higher minimum 128 kbs connection for a readily acceptable content performance. Thus, a tethered connection is conventionally required.

Further, the Internet, as presently constructed, is not optimized to guarantee any consistent level of data delivery. Consequently, playback devices typically implement stream data buffers of sufficient scale to mask typical variations in the delivery rate of the connected streaming data channel. While data buffers of nominal size can largely mask the variations in streaming data delivery, significant interruptions at any point along the Internet can exhaust the buffer and stop the presentation of content to the user.

### SUMMARY OF THE INVENTION

Thus, a general purpose of the present invention is to provide an efficient system supporting the streaming of multi-media content to playback devices without compromise of the user experience while permitting the untethered use.

This is achieved in the present invention by providing a multi-media content playback system capable of autonomous operation in a virtual program format that includes a memory store providing for the storage of a plurality of digital content, a player interface supporting the transfer of a digital content stream to a content player and for receiving user input, and a content control system coupled between the memory store and the player interface. The content control system includes a network proxy that is coupleable through a network to a content server and a control file server and a program control system that is responsive to the programmatic evaluation of a control file. Based on the autonomous evaluation of a control file, digital content is selectively transferred from the content server to the memory store. The control file further defines a dynamic program order for selectively streaming the plurality of digital content from the last-element cache through the player interface as the digital content stream. The dynamic program order is determined based on the control file subject to predetermined selective variation based on the user input.

An advantage of the present invention is that the system supports a programmed style of content play, subject to user selection of any of multiple content channels and selective limitation on particular content objects.

Another advantage of the present invention is that the preferred embodiments of the system implement a rules-based controller that enforces compliance with content licensing restrictions, such as those codified in the Digital Millennium Copyright Act.

A further advantage of the present invention is that the preferred embodiments of the system provide for appropriate logging and subsequent reporting of content play as may be necessitated by content licensing requirements.

Still another advantage of the present invention is that the rules-based controller of the preferred embodiments operates based on content identification for application of licensing restrictions. Thus, any available content can be incorporated into the programmed content play.

Yet another advantage of the present invention is that autonomous player operation, based on the operation of the rules-based program controller, does not require a permanently tethered connection. Player systems can operate untethered for extended periods of time while remaining completely compliant with any applicable content licensing constraints. Thus, any player system minimally capable of implementing a DRM client and content player can be used within the streaming content model, yet operate untethered without loss of any source control over the licensed content.

### BRIEF DESCRIPTION OF THE DRAWINGS

These and other advantages and features of the present invention will become better understood upon consideration of the following detailed description of the invention when considered in connection with the accompanying drawings, in which like reference numerals designate like parts throughout the figures thereof, and wherein:

FIG. 1 provides a detailed block diagram of an implementation of a server-side system suitable for supporting content delivery to a last-element streaming cache system in accordance with a preferred embodiment of the present invention;

FIG. 2 provides a detailed block diagram of a client-side system implementing a last-element streaming cache system in accordance with a preferred embodiment of the present invention;

FIG. 3 provides a process flow of the top-level run-time operation of a last-element streaming cache system in accordance with a preferred embodiment of the present invention;

FIG. 4 provides a process flow of the channel data streaming and operation and related control of a last-element streaming cache system in accordance with a preferred embodiment of the present invention;

FIG. 5 provides a process flow showing the responsive operation of a server-side system to requests by a last-element streaming cache system in accordance with a preferred embodiment of the present invention;

FIG. 6 provides a detail illustration of the content and organization of a preferred embodiment of the last-element cache of the present invention;

FIG. 7 is a block diagram showing the content and process controls of the rules engine in accordance with a preferred embodiment of the present invention; and

FIG. 8 is an illustration of the operation of a channel program subject to the determination of compliance determinations for content playing in accordance with a preferred embodiment of the present invention.

### DETAILED DESCRIPTION OF THE INVENTION

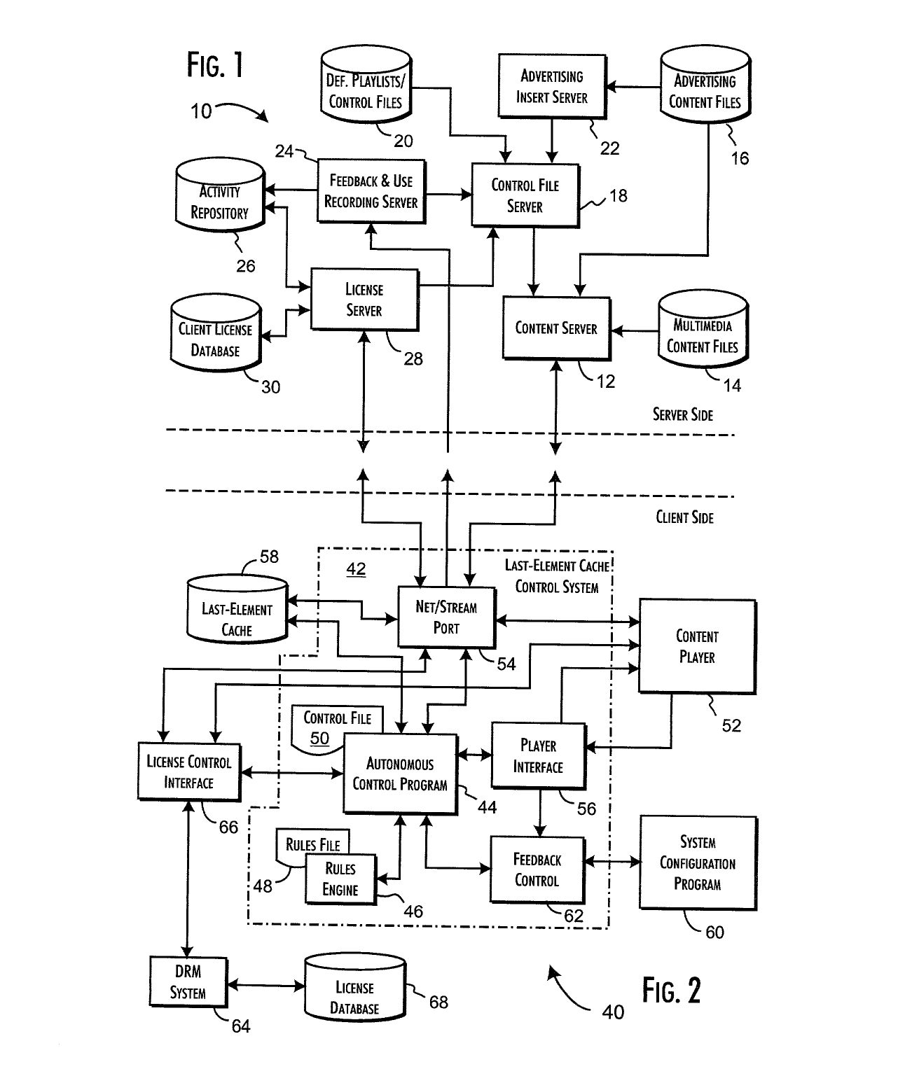

As generally shown in FIGS. 1 and 2, the present invention provides for a content server system 10 that supports the transfer and tracking of content provided through a network connection for play by a client platform 40. The transfer and tracking of content play is managed by the autonomous operation of a rules-based control program that enforces applicable licensing constraints on the frequency and order of playing different content objects. The control program further preferably provides for the dynamic adaptation of an overall channel program order of playing available discrete content objects.

Preferably, the content available to the control program is stored locally on the client platform 40 within a last-element cache and managed by operation of a last-element cache control system 42 executed on the client platform 40 as described in co-pending U.S. Applications “Client-side Last-Element Cache Network Architecture Streaming,” U.S. patent application Ser. No. 09/946,649, Hudson et al. and “System and Methods for Performing Last-Element Streaming,” U.S. patent application Ser. No. 09/947,048, Hudson et al., both of which are assigned to the assignee of the present invention and hereby expressly incorporated by reference.

Specifically, the content server system 10 is preferably a logically associated complex of servers interoperating to support the remote retrieval of content, develop and support the retrieval of control files, and provide centralized server-side DRM support. For the preferred embodiments of the present invention, a content server 12 is provided to enable the retrieval of licensed and unlicenced multimedia content files 14 and advertising related content files 16. The content server 12 also enables the retrieval of control files as developed and provided by a control file server 18.

For the preferred embodiments of the present invention, the control file server 18 operates to organize the available multimedia content into a variety of distinctive programming content channels analogous to multiple radio broadcasts serving different market demographics, such as top-40, jazz, and rock & roll. The channel format framework, identifications of other available content servers, which may be the preferred source of particular multimedia content, times when particular content is available, the geographic locations and aggregate bandwidth limits of particular content servers 12, and other basic data is preferably provided from a database 20 of basic control files and templates. Advertising inserts, promotions, and other sponsored content are preferably organized and provided by an advertizing insert server 22 to the control file server 18. New content and new advertisements, promotions and other inserts are identified and thus effectively made available to the control file and advertising insert servers 18, 22 by updating the basic control files and templates held by the database 20.

Other information, relating statistical use, explicit preferences, including end-user qualified retrieval windows, and end-user interest feedback related to the content provided to client platforms 40, is preferably received periodically and recorded by a feedback and use recording server 24 to an activity repository 26. This reported use information is also subsequently provided on-demand to the control file server 18. Thus, when any particular client platform 40 requests an updated control file, the control file server 18 preferably responds by dynamically generating a responsive updated control file based in various parts on the content channels referenced in the update request, the last control file or files retrieved by the client platform 40, the client platform 40 specific and aggregated feedback information previously recorded, and the multimedia and advertising content files that are available from this or another content server system 10. The resulting updated control file, as dynamically generated, can thus be made as personalized to a specific client platform 40 and end-user as desired, both for the esthetic enjoyment purposes relative to the end-user and to strategically distribute the content request load imposed by the specific client platform 40 temporally across the appropriately corresponding content servers 12. That is, the control file server 18, based in part on the preferred update and content retrieval windows reported by last-element cache control systems 42, can provide specifications within the control files of when and where particular content is preferred to be retrieved.

The client platform 40, implementing a preferred last-element cache control system 42 and associated components, is shown in FIG. 2. In the preferred embodiments of the present invention, an autonomous control program 44 is provided as the central element of the cache control system 42. The autonomous control program 44 continuously interoperates with a rules engine 46 to define the operational state of the cache control system 42 in response to various inputs and operating conditions. A rules file 48, preferably implemented as a state-transition script, is used to configure the operation of the rules engine and thus effect much of the fundamental behavior of the autonomous control program 44. Preferably, part of this behavior is the parsing evaluation of a control file 50 to determine the major activities of the autonomous control program 44. Alternately and as initially implemented in the preferred embodiments of the present invention, the rules file is hard-coded into the state transition operation of the rules engine 46.

A control file, in accordance with a preferred embodiment of the present invention, includes multiple sections, each containing parseable directives, that provide a control file identifier, define directly or implicitly a preferred control file update schedule, a recommended priority listing of the content server systems 10 that can be used by the client platform 40, playlists for subscribed content channels, and various meta-directives identifying other retrievable control files as well as default and preferred content server system sources for categorical types and specific instances of content. The update schedule may be implemented logically as an annotation of the ordered list of available content server systems 10 indicating the preferred and allowable time windows usable by the cache control system 42 to retrieve updated control files and additional content.

In the simplest case, a channel playlist is preferably a linearly ordered list of the content files, multimedia, advertising, and other content that are to be streamed to a content player 52 when the corresponding program channel is selected. A channel playlist may also include directives or meta-directives indicating alternative selections of content that may be substituted under varying circumstances. Meta-directives are preferably also used in the control files to specify the logical inclusion of additional control files, for example, to extend or provide alternate channel playlists and to specify source servers from which specific types or instances of content are to be retrieved. Consequently, the autonomous control program 44 is capable of a wide degree of operational flexibility based on the directives provided in control files 50 and, further, can be behaviorally modified and extended by suitable changes made to the rules file 48.

The cache control system 42 includes a network proxy 54 to the external network connected to the client platform 40 and a player interface 56 that supports interoperation with the content player 52 with the cache control system 42. In the preferred embodiments of the present invention, the network proxy 54 is implemented as a transparent intercept for network communications to and from the client platform 40. Nominally, all network requests are passed by the network proxy 54. Requests made by the content player 52 for content from a content server system 12, or other predefined network content source, can be intercepted and redirected, as determined by the autonomous control program 50, through the network proxy for satisfaction from a last-element cache 58. That is, the cache control system 42 initiates a stream data read of the corresponding content from the last-element cache 58 through a network stream port implemented by the network proxy 54 and connected to the content player 52. The content player 52 thus receives the requested stream data in a manner logically indistinguishable from a conventional network data stream, though with certainty that the stream data will be received without interruption and at the full data rate of the requested content, since the functional stream data path is local to the client platform 46. In the preferred embodiments of the present invention, a pseudo-domain can be explicitly associated by the cache control system 42 with the contents of the last-element cache 58. Requests by the content player 52 that reference this pseudo-domain are automatically directed through the network proxy 54 to the last-element cache 58.

The player interface 56 is provided to connect the various content player controls as inputs to the autonomous control program 44. This allows the autonomous control program 44 to transparently intercede in the operation of the content player 52 and provide for the selection and streaming of content from the last-element cache 58. Where the selected content identified by the control inputs from the content player 52 is outside of the scope of the content managed by the cache control system 42, the content request is simply passed by the network proxy 54 to the external network connection. The content player controls are then supported to work as conventionally expected.

In the preferred embodiments of the present invention, where a channel playlist is used to determine the selection and order of content streamed to the content player 52, the player interface 56 supports the channel selection and specific channel operation controls, including the start, stop, pause, and next track controls. Selection of specific playlist identified content, either explicitly or by repeat playing of the content through use of the previous track control, is preferably not supported. Rather, the operation of the autonomous control program 44 is defined through the specification of the rules file 48 to base content selection on the applicable channel playlist and to refine the attributes of the selected playlist, such as through the selection of alternate content and to enforce a minimum frequency that any particular playlist identified content can be streamed to the content player 52. The rules file 48 is thus used to define and enforce playlist handling consistent with licensing requirements as may be generally or specifically associated with the content. In particular, the rules file 48 is preferably constructed to ensure that playlist content is played within the legal requirements necessary for the channel streams managed by the cache control system 42 to qualify as digital transmissions under the provisions of §114, 115 of Title 17 of the U.S. Code, as further defined by the Digital Millennium Copyright Act (DMCA) of 1998, and thereby qualify for the compulsory licensing provisions for digital transmissions.

In addition to the playlist controlled content, other licensed content can be stored in the last-element cache 58. The rules file 48 can provide for the recognition of licensed content otherwise conventionally requested and streamed to the content player 52. An image of such other content can be copied to the last-element cache 58 when initially retrieved through the conventional operation of the content player 52. Subsequent requests for the streaming retrieval of the content by the content player 52 can be intercepted by the network proxy 54 and effectively redirected by the autonomous control program 44 to the image copy present in the last-element cache 58.

A cache control system configuration program 60 is preferably utilized to capture the explicit preferences of an end-user of the content player 52. Implicit preferences are also preferably identified through recognition of explicit control actions and possibly patterns of actions intercepted by the player interface 56. These preferences are provided to a feedback control subsystem 62 of the cache control system 42. The collected explicit preferences preferably include end-user selected frequency, timing, and priority of control file and content updates, channel category interests, and other similar information. Implicit preferences are preferably collected by the feedback control 62 by recognizing end-user actions with regard to specific content, such as activation of the next track control when the content is played. The collected explicit and implicit preferences are preferably stored into the last-element cache 58 by operation of the autonomous control program 44 and subsequently forwarded in connection with a control file update request to a feedback and use recording server 24. Locally, the implicit preferences can also be subjected to interpretation by the autonomous control program 44, ultimately based on the specification of the rules file 48, to select alternate content from playlists in place of content repeatedly skipped. The selection of such alternate content and potentially even alternate channel playlists may be also influenced by the explicit preferences provided by the end-user.

The cache control system 42 preferably interacts with a DRM system 64 through an operating system supported license control interface 66. Direct interactions by the cache control system 42 are supported to enable authenticated access to the last-element cache 58 based on a conventional DRM license managed by the DRM system 64 and stored by a conventional DRM license database 68. Through use of the services of the DRM system 64, the cache control system 56 can maintain the entire last-element cache 58 as an encrypted file system object. In the preferred embodiment of the present invention, the last-element cache 58 appears on the local file system is a single, encrypted file. All data stored within the last-element cache 58, including persistent copies of the rules and control files 48, 50, preferences from the feedback control 62, playlist content, and other content, are stored encrypted based on the DRM license for the last-element cache 58. Even content received through the network proxy 54 in encrypted form is further encrypted using the DRM license for the last-element cache 58. While DRM encryption and licensing protocols are conventionally considered secure, if not highly secure, such double encryption under independent licenses ensures that any individually licensed content stored in the last-element cache 58 is secure.

Consistent with normal operation of conventional content players 52, access to the license control interface through, as necessary, the cache control system 42 is supported. This allows licensed content, decrypted once under the DRM license of the last-element cache 56, to be finally decrypted under the DRM license applicable to the specific content as streamed to the content player 52. Where the content license must be obtained remotely from a license server 28, the network proxy 54 also supports routing of the corresponding network requests to the external network connection.

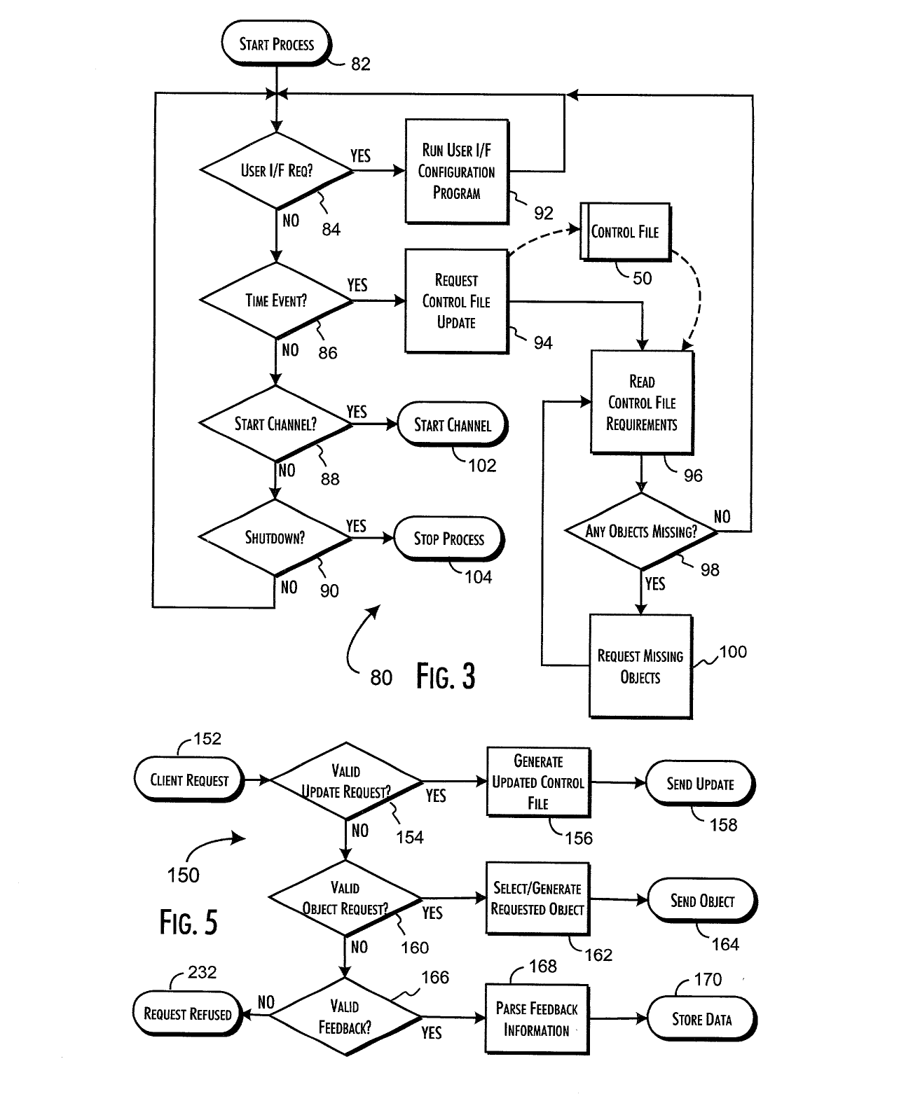

The preferred flow 80 for the main process of the autonomous control program 44 is shown in FIG. 3. The primary operations of the main loop, which preferably can be defined or altered based on the rules file 48, include determining whether to start 82 he user configuration program 92, whether a timed event 86 defined by a control file has occurred, whether a request to start 88 a playlist channel has been made by the end-user or other local program, and whether a shutdown request 90 has been received. Preferably, the response to a configuration program 84 start request is to invoke 92 the configuration program 60 in a separate thread or process as appropriate and supported by the underlying operating system to avoid blocking execution of the main loop.

The occurrence of a timed event 86 is preferably handled by the creation of a separate process or thread that, in turn, parses the current control file to determine the action to be taken. Typically, the action involves retrieval of an updated control file or some particular content. To ensure that the most current sources of content are used, an updated control 50 may be first requested 94. In general, an updated control file 50 will be provided by a control file server 18 in response to any valid control file update request 94. The now current control file 50 is then read 96 to identify any present actions to be taken. In general, all objects referenced in the control file, such as other included control files and content, are checked 98 for existence in the last-element cache 58. Each missing object is then retrieved 100 from a control file designated or default content or control file server 12, 18. To allow for the recursive retrieval of control files 50, the current control file 50 and any newly retrieved control files 50 are reread 96 and checked 98 for references to missing objects.

Objects designated within the control file 68 for deferred retrieval are skipped until a timed event 86 occurs within the time window specified for the retrieval action. Timed events are set and, as appropriate, reset each time a parsing of the current control file encounters a deferred retrieval directive. Once all objects identified in the current control file for present retrieval have been retrieved, the current timed event thread or process is terminated.

When a start channel event is received 88, a new process or thread is created within which to start 102 channel operations. A channel processing flow 110, consistent with a preferred embodiment of the present invention, is detailed in FIG. 4. Following from a start channel 102 event, the current control file 50, if not currently in memory, and a list of the current contents of the last-element cache is read 112 from the last-element cache 58. The control file 50 is checked for validity 116, specifically including whether the current control file has expired and, if not, whether the control file includes a playlist for the currently selected content channel. If the control file is determined to be not valid for some reason, an updated control file is requested 92 and the retrieved control file is again read 112 and evaluated for validity 116.

Once a valid control file obtained, the control file is parsed 96 to determine 98 whether the objects referenced by the control file 50 are available in the last-element cache 58. Missing objects, not subject to a deferral directive, are requested 100. To avoid delay in initiating the streaming of channel content, the retrieval of missing objects 100 is preferably executed as a background task, allowing the channel processing flow 110 to continue.

Based on the rules engine file 48 specifications and the current control files 50, the autonomous control program 44 constructs 118 an active channel playlist 120. Preferably, the appropriate channel playlist section of the control files 50 is evaluated against user preferences and feedback information, as well as the currently available content in the last-element cache to select between default and alternative content in constructing 118 the active playlist 120. This evaluation can also be used to, in effect at least, annotate the current control files 50 and thereby affect the retrieval prioritization of missing objects. The annotation may also be used to cancel the retrieval of selected content objects 100 that, as a result of the evaluation, will not be included in any active playlist 120.

The autonomous control program 44 then checks 122 whether the content player 52 is currently running. If the content player 52 is not running, the content player 52 is started in a separate process 124. Once started, the initial content elements of the active playlist 120 are selected 126 and setup to be streamed from the last-element cache 58 to the content player 52 through the cache control system 42. The content player 52 is then provided with the corresponding content request and prompted to issue the request 128 through the player interface 56. The content player 52 and relevant content player controls 130 are then monitored 132 for content requests. In particular, when the content player 52 completes the streaming of some particular content, a next track request is automatically generated by the content player 52. A next track request can also originate from the corresponding player control 130. In both cases, the player interface 56 recognizes the request and initiates the selection 126 and streaming setup 128 of the next track of content as determined from the active playlist 120.

Preferably, a content player pause control is handled internally to the content player 50. The player controls 130, however, are preferably examined 134 to explicitly identify stop commands, which result in the termination 136 of the current channel processing flow 110. Other player controls 130, such as a play previous track command, are preferably ignored.

Referring again to FIG. 3, a preferably last event checked 90 in the main process flow 80 main loop is a shutdown event. In response to the detection 90 of a shutdown event, the memory resources of the cache control system 42 are released and the DRM system 64 notified of the application termination relative to the license to the last-element cache 58. The main process flow 80 is then terminated 104. This results in the termination of the execution of the cache control system 42 and precludes access to the content of the last-element cache 58 at least until the cache control system 42 is restarted.

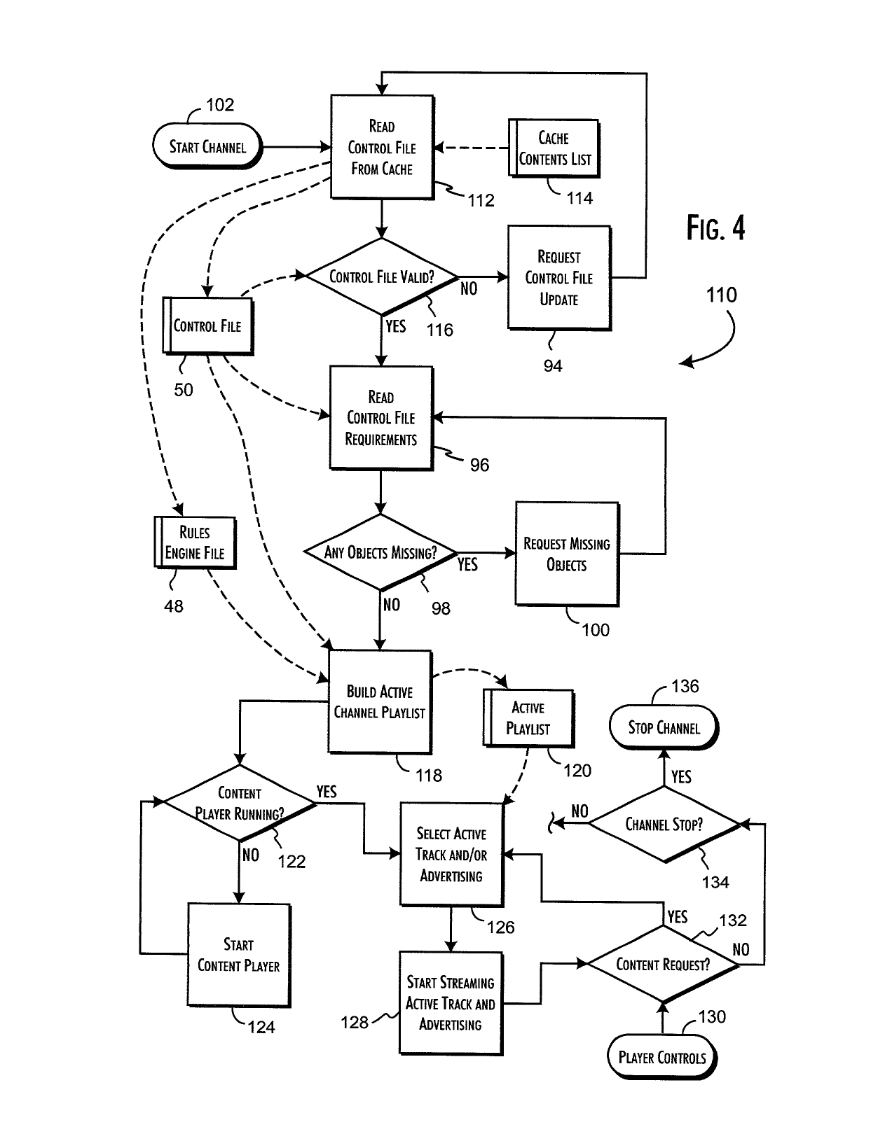

The preferred process flow 150 implemented by a content server 12 and control file server 18 is generally shown in FIG. 5. When a client request is received 152, the request is first checked 154 to determine if the request is a valid request for an update control file 50. A valid control file update request is processed by the control file server 18 to dynamically generate 156 the updated control file 50, which is then returned to the requesting client platform 40.

If the request is not a request for an updated control file 50, the request is checked 160 to determine if the request is a valid request for some content held or managed by the content server 12. A valid request for managed content results in the content being selected or, as appropriate, generated 162 and returned 164 to the requesting client platform 40.

If the request is to provide feedback information from the cache control system 42, the request is first reviewed for validity 166, preferably to ensure that the information to be provided is from a known client platform 40. The information provided in connection with a valid feedback request is then parsed 168 by the feedback and use recording server 24 and stored 170 to the activity repository 26 for subsequent reference, preferably with regard to the generation 156 of control files specific to the client platform 40 that originated the information and as an aggregated basis for influencing the generation 156 of updated control files in general. Invalid requests and requests for content or other resources outside of the managed scope of the control file and content servers 12, 18 are refused 232.

In accordance with the preferred embodiments of the present invention, the dynamic evaluation of the control files 50 and rules files 48 permits the autonomous control program 44 to dynamically define a content program that is streamed to the content player 52. The structure of the content program is defined in the control files 50 as a sequence of content objects specified by some combination of one or more content object characteristics. In the preferred embodiments of the present invention, the content object characteristics are expressed in content meta-data provided in correspondence with the content objects. The form of a content meta-data description of a content object is generally a list of identifiers that variously characterize the corresponding content object. The possible identifiers associated with any particular content object will depend on the type of the content object. In general, the content meta-data will include identifiers that characterize a content object by file name, type (advertisement, announcement, song, etc.), style (music genre), pace (beats per second, etc.), song name, artist name, album name, and content playing time. Other categories of content characterizing identifiers may be used depending on the nature of the content objects being described.

Preferably, the content meta-data is stored in the last-element cache 58 with the content objects as both are received from the content server 12. A last-element cache 58, as shown in FIG. 6, is preferably formed as a file 180 within the filesystem structure of a persistent data store, such as a disk drive, maintained by the client platform 40. The file 180 preferably provides for the separate storage of configuration files 182, including the control files 50 and rules files 48, the content objects 184, and the content meta-data 186. Blocked content 188 is a meta-data type list of content objects, identified through the “next” selection operation of the content player, that are to be skipped in the subsequent preparation of playlists. A database log 190 stores an identification of those content objects that have been played and are subject to reporting to the feedback and use recording server. A history database 192 stores meta-data type list of the content objects that have been played or are on the active playlist awaiting playing within a sliding time-window defined as the longest period of time that may be considered by the rules engine 46 in determining whether to add any particular content object to the active playlist 120. A cache meta-data file 194 preferably records the indexing information needed by the autonomous control program 44 to access and store the various data within the last-element cache 56.

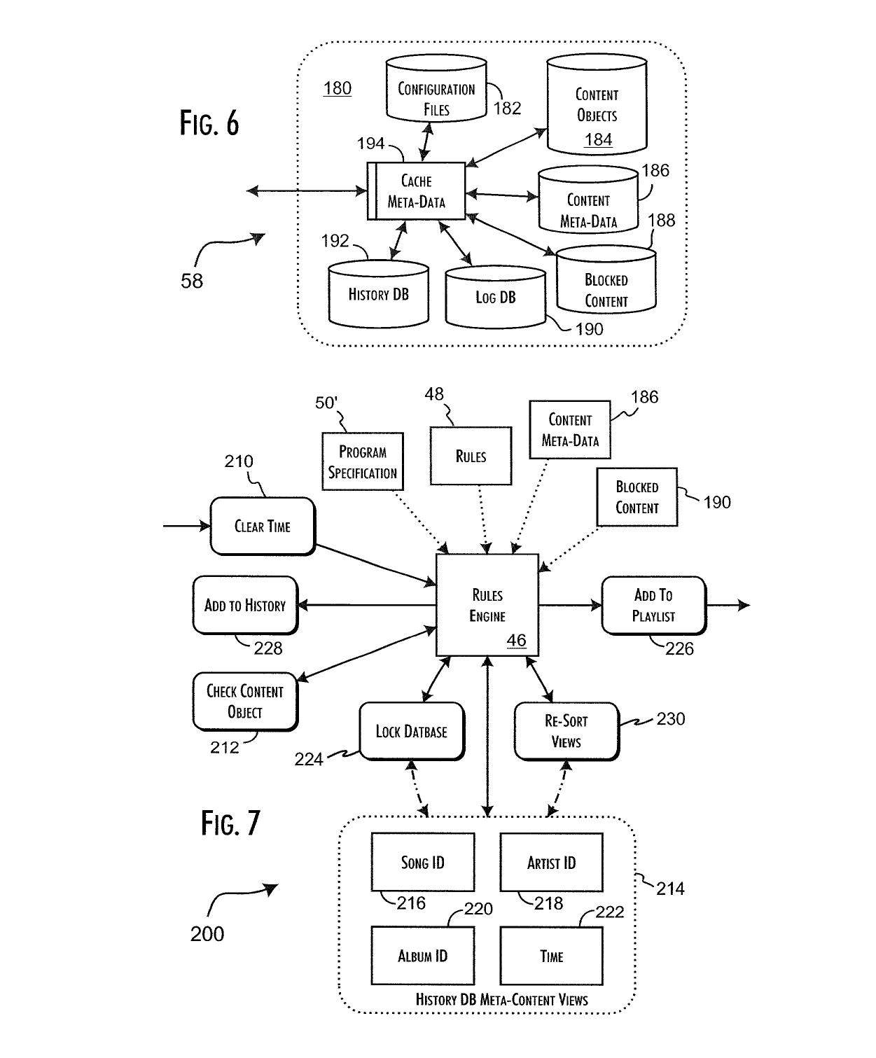

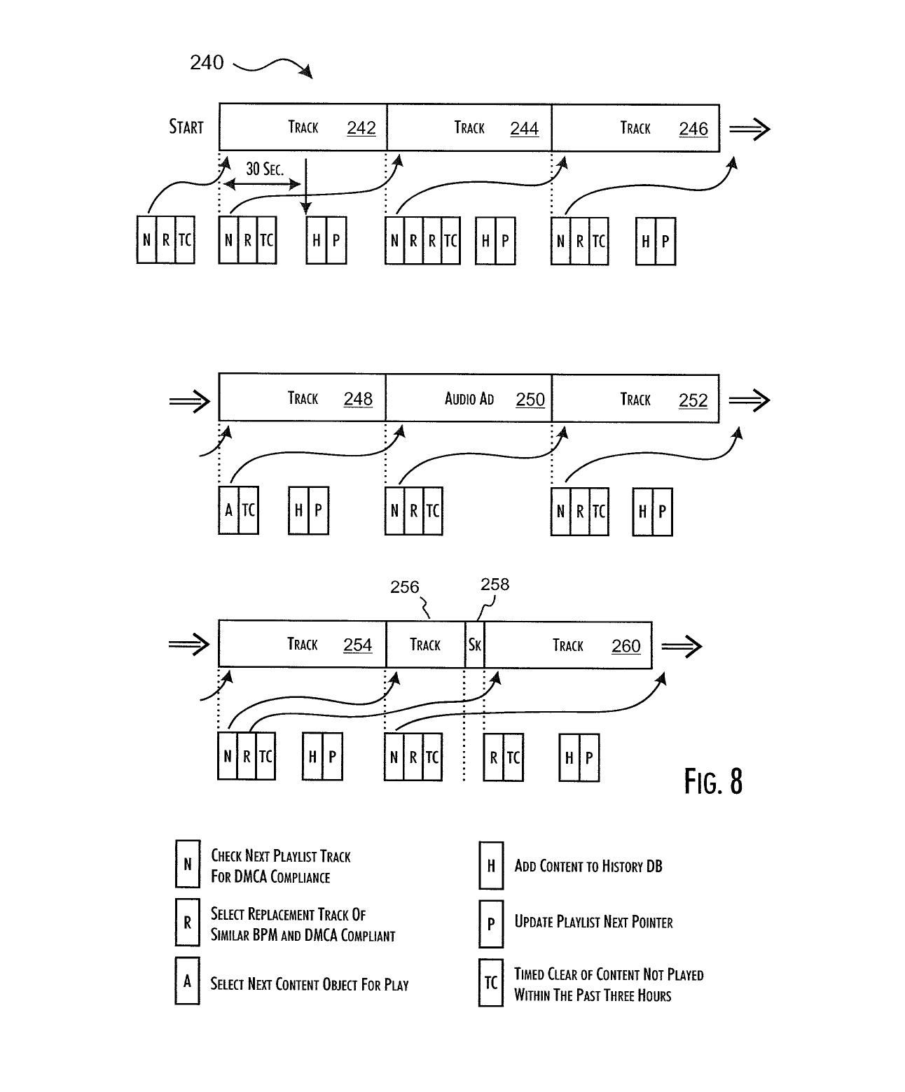

Referring to FIG. 7, to build the currently active channel playlist 118, the autonomous control program 44 logically provides a program specification 50′, as determined from the current control files 50, to the rules engine 46. The rules engine 46 also takes as inputs the current rule set 48, the content meta-data 186, and the blocked content meta-data 190. On initialization of the rules engine 46 with a new program specification 50′, representing a new channel selection, a clear time 210 call is made from the autonomous control program 44 to the rules engine 46. In response, the rule engine 46 clears the current entries in the history database 192.

Based on the program specification 50′ and content meta-data 186, the rules engine 46 progressively evaluates the rules 48 and interoperates with the autonomous control program 44 to identify a content object available in the last-element cache 58 as a candidate for addition to the active play list 120. In the preferred embodiments of the present invention, the operation of the rules engine 46 is invoked incrementally to place content objects are on the active playlist 120. The program specification 50′ may specify the program directly by listing an ordered selection of, for example, music tracks, advertisements, and announcements. In this case, the corresponding content objects may be identified in the program specification 50′ directly by file names.

Alternately, the program specification 50′ may specify program selections by establishing a type-specified, repeating pattern of, for example, three music tracks, advertisement, announcement, two music tracks, announcement, two music tracks, advertisement. The sequence of music tracks may be further qualified by an ordered specification of genres and pacing for each music track. Extended patterns with varying selections for different types of advertisements and announcements and of the progression of music content pace and genre selection may be specified to establish a distinctive esthetic quality for the channel program. By selecting content objects specified by content meta-data characteristics, the channel program specification enables a highly dynamic presentation of the channel program.

Thus, based on the program specification 50′ and reference to the content meta-data 186, a candidate content object is selected 212 for potential addition to the active Playlist 120. The reference to the content meta-data 186 permits a group of content objects to be identified, consisting of those content objects that generically meet the program specification 50′ requirements for the next content object to be added to the active playlist 120, from which the candidate content object is selected 212. Preferably, the candidate content object is selected at random from the identified group of content objects, subject to the exclusion of any content objects identified as blocked content 190.

In accordance with the preferred embodiments of the present invention, the selection of a candidate content object is further qualified based on the licensing requirements of the DMCA. In order to meet the compliance requirements of the DMCA, the following rules are implemented by the rules engine 46 of the present invention. Only content objects that are subject to DMCA licensing are considered under these rules. Further, any intervening advertising or other non-DMCA subject content is ignored except to the extent that such content may contribute to the time-distribution of DMCA content under the compliance rules. Failure to meet the requirements of any one rule results in the at least temporary exclusion of the content object from the active playlist 120. Excluded content objects may be subsequently reconsidered for inclusion, preferably based on the random selection of the content objects as part of the selection process of 212.

The first DMCA compliance rule rejects the playlist addition of a candidate content object if the addition of the candidate content object would potentially result in a repeat playing of the content object within a three-hour time window. Second, a candidate content object is rejected if addition would result in the potential playing of four consecutive content objects by the same artist. Third, a candidate object is rejected if addition would result in the potential playing of three consecutive content objects are from the same album. Fourth, a candidate object is rejected if addition would result in the potential playing of four content objects from the same album within a three-hour window. Finally, a candidate object is rejected if addition would result in the potential playing of five content objects by the same artist within a three-hour window.

To evaluate the DMCA compliance rules, a set of meta-content views 216 are developed, based on the contents of the history database 192. The meta-content views 216 are preferably sorted indexes of the history database 192 contents to permit rapid lookup of the playlist order of different meta-data characterizations of content objects that have been played or are awaiting play on the active playlist 120. In a preferred embodiment of the present invention, these views include an index of song 216, artist 218, and album 220 identifiers along with a time index 222.

On selection of a candidate content object, compliance with the DMCA rules is initiated by locking 224 the current views 216. The necessary indexes 216, 218, 220, 222 are then accessed. A compliance failure against any rule results in a next candidate content object being selected for evaluation. When a compliant candidate content object is found, the content object is added 226 to the playlist 120. The lock 224 on the views 216 is then released.

When a content object is added to the playlist 120, a corresponding entry is made 228 in the history database 192. The entry in the history database 192 is preferably made tentative, pending an actual playing of some sufficient portion of the content to qualify under the DMCA as played content. The tentative entry permits evaluation of the DMCA compliance rules for subsequently considered content objects. For the preferred embodiments of the present invention, a content object is considered played after the first thirty seconds of the content have been actually played. The tentative status of the history database entry is removed when the content object is qualified as having been played. With each modification of the history database 192 contents, the rules engine 46 preferably initiates an update 230 of the meta-content views 216.

A possible construction of a channel program in accordance with a preferred embodiment of the present invention is illustrated in FIG. 8. In connection with a start channel event 102, the rules engine 46 is invoked first to select a next fully qualified content object 242 for addition to the playlist and, second, to select an alternative fully qualified content object. This alternative content object is preferably selected in anticipation of a content player 52 directed skip of the first selected content object. Thus, rather than artificially progressing through the channel program in response to skip commands, replacement content objects that are consistent with the content meta-data characteristics of the channel program slot are provided when any content object is skipped. The current channel program pointer is set to the selected content object 242 and the history database 192 is updated to reflect the passage of time. The channel program next initiates the streaming 128 of the content object 242 at the current active playlist pointer to the content player 52.

Following generally from the streaming of the content object 242, the rules engine 46 is again invoked to select primary 244 and alternative fully qualified content objects. The history database 192 is again updated. Additionally, after the passage of thirty seconds of streaming the content object 242, the history database 192 is updated to include an identification of the content object 242 as having been played. The channel program pointer is also updated to reference the next content object 244 to stream.

Multiple successive invocations of the rules engine 46 may be necessary to select a next fully qualified primary or alternative content object. As indicated during the streaming of the content object 244, multiple invocations may be required to select a suitable alternative content object that matches the content meta-data characteristics of the primary content object.

As indicated in relation to the streaming of the content object 248, an advertisement or announcement, as determined by the specification of the channel program, is selected for insertion as a next content object 250 to be played. In accordance with the preferred embodiments of the present invention, the content object 250 may not be skipped. Any activation of the next content control of the content player 52 in relation to the content object 250 is preferably ignored. As with other content objects, next primary 252 and alternate content objects are selected during the streaming of the content object 250.

Selection of the content player 52 next content control during the streaming of a non-advertisement or announcement content object, such as content object 256, is supported. The skip event 258 is recognized and an immediate switch is made to streaming of the alternate content object 260, as selected during the streaming of the prior content object 154. Since next primary and alternate content objects were already selected for the next program slot, only a new alternate content object need be selected during the streaming of the now current content object 260.

Consequently, through successive selection of qualified content objects by the rules engine 46, a continuous and dynamically defined channel program can be streamed to the content player 52. Since the DMCA compliance rules are continuously applied to the content selections that may be subject to DMCA licensing, the channel program can run at length untethered from the control server 18 and license server 28. Furthermore, since the channel program can be indirectly specified by a lengthy pattern of content meta-data characteristics, rather than a fixed playlist of explicitly defined content, the resulting channel program is not perceived as repetitious. Thus, even with a limited capacity of content objects stored in the last element cache, the perceived repeating period of the channel program is quite long.

Additionally, the dynamic variability of the channel program can be greatly extended by the progressive addition or replacement of even small numbers of the content objects stored by the last-element cache 58. Only a few new content objects need be updated in connection with the tethered retrieval of each new control file to esthetically refresh the channel program. Of these new content objects, many will be new advertisements, announcements, or other relatively short non-DMCA licensed content objects. Such content objects are typically short in comparison to most DMCA licensed content objects. As a result, only a limited bandwidth and limited download time is required to refresh a channel program.

Thus, a system and methods providing for the tethered and untethered streaming of multimedia content in a channel program format on a client platform and fully compliant with DMCA licensing requirements have been described. In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A system supporting the playback of multi-media content in a virtual program format through a content player, said system comprising:
a) a memory store providing for the storage of a plurality of digital content;
b) a player interface supporting the transfer of a digital content stream to a content player and for receiving user input; and
c) a content control system coupled between said memory store and said player interface, said content control system including a network proxy, coupleable through a network to a content server and a control file server, and a program control system, responsive to the programmatic evaluation of a control file, to selectively transfer digital content from said content server to said memory store and to define a dynamic program order for selectively streaming said plurality of digital content from said lost-element cache through said player interface as said digital content stream, wherein said dynamic program order is determined based on said control file subject to predetermined selective variation based on said user input.

2. A system supporting the playback of multi-media content in a virtual program, said system comprising:
a) a last-element cache memory providing for the storage of a plurality of digital content;
b) a content player operative to perform a digital content stream and provide user input; and
c) a cache control system coupled between said last-element cache and said content player, said cache control system including a network proxy, coupleable through a network to a content server and a control file server, and a program control system, responsive to the programmatic evaluation of a control file, to selectively transfer digital content from said content server to said last-element cache memory and to define a dynamic program order for selectively streaming said plurality of digital content from said last-element cache to said content player as said digital content stream, wherein said dynamic program order is determined based on said control file subject to predetermined selective variation based on said user input.

3. The system of claim 2 wherein said plurality of digital content includes a plurality of discrete content objects and wherein said program control system is responsive to a plurality of predefined constraints on the order and frequency that said discrete content objects are streamed to said content player such that said dynamic program order is compliant with said plurality of constraints.

4. The system of claim 3 wherein said cache control system stores said user input relative to said discrete content objects in a user input store and wherein said program control system is coupled to said user input store to qualify said dynamic program order with respect to said user input subject to compliance with said plurality of constraints.

5. The system of claim 3 wherein said plurality of constraints include the constraints defined by the Digital Millennium Copyright Act.

6. The system of claim 5 wherein said user input specifies the blocking of a corresponding one of said discrete content objects.
